(19) United States
(12) Patent Application Publication
(10) Pub. No.: US 2017/0166179 A1
(43) Pub. Date: Jun. 15, 2017

(54) BRAKE NEGATIVE PRESSURE CONTROL DEVICE FOR VEHICLE

(71) Applicant: TOYOTA JIDOSHA KABUSHIKI KAISHA, Toyota-shi (JP)

(72) Inventor: Yasushi Fujita, Toyota-shi (JP)

(73) Assignee: TOYOTA JIDOSHA KABUSHIKI KAISHA, Toyota-shi (JP)

(21) Appl. No.: 15/369,318

(22) Filed: Dec. 5, 2016

(30) Foreign Application Priority Data
Dec. 14, 2015 (JP) 2015-243362

(51) Int. Cl. B60T 13/72; F02D 9/02; F02D 41/30; B60T 13/52

(52) U.S. Cl. CPC B60T 13/72; B60T 13/52; F02D 9/02; F02D 41/3094; F02D 2250/41

(57) ABSTRACT

A brake negative pressure control device for a vehicle includes an ECU. The ECU is configured to (i) control a first fuel injection valve and a second fuel injection valve, when the ECU determines that a negative pressure in a negative pressure chamber is insufficient, such that a ratio of a fuel injection amount by the first fuel injection valve is decreased and a ratio of a fuel injection amount by the second fuel injection valve is increased; and (ii) control an opening degree of the throttle valve, when the ECU determines that the negative pressure in the negative pressure chamber is insufficient, such that the opening degree of the throttle valve at the time when the ECU determines that the negative pressure is insufficient is smaller than an opening degree of the throttle valve at the time when the ECU determines that the negative pressure is not insufficient.

### INCORPORATION BY REFERENCE

The disclosure of Japanese Patent Application No. 2015-243362 filed on Dec. 14, 2015 including the specification, drawings and abstract is incorporated herein by reference in its entirety.

### BACKGROUND

1. Technical Field

The present disclosure relates to a device for controlling an intake negative pressure of an engine to be supplied to a brake booster of a vehicle, and particularly, belongs to a technical field of a control to increase the intake negative pressure.

2. Description of Related Art

Conventionally, a braking system of a vehicle is generally configured to supply a negative pressure (an intake negative pressure) of an intake passage in an engine to a brake booster, thereby generating an assist force to amplify a brake pedal force. For example, a cylinder injection engine described in Japanese Patent Application Publication No. 2001-182587 (JP 2001-182587 A) focuses on a fact that an intake negative pressure is very small (an intake pressure is high) in a stratified charge combustion mode in which a throttle valve is substantially fully opened, and is configured to increase the intake negative pressure to the maximum by closing the throttle valve at the time of fuel cut, so as to store the intake negative pressure in a brake booster.

### SUMMARY

In the meantime, nowadays, in order to attempt a reduction in fuel consumption rate in a gasoline engine, a closing timing of an intake valve is changed to a retard side by a variable valve mechanism in a low-middle load operation region, so as to decrease a pumping loss due to the throttle valve. When the closing timing of the intake valve is retarded, spit-back of the intake air from a cylinder to the intake passage occurs and the pumping loss is decreased. However, the intake negative pressure is not so large, so a sufficient brake negative pressure may not be able to be secured in some cases.

That the intake negative pressure is not so large as such is similar to a time of the stratified charge combustion mode of the engine as described in the conventional example (JP 2001-182587 A), so it is conceivable that the throttle valve is closed at the time of fuel cut so as to increase the intake negative pressure as much as possible. However, the fuel cut is not necessarily performed when it is necessary to increase the intake negative pressure, so such a situation in which the intake negative pressure is insufficient may occur.

In view of this, it is conceivable that an electric vacuum pump (negative pressure pump) may be provided so as to supply the intake negative pressure to the brake booster from the engine as described above, and further, the negative pressure (the pump negative pressure) is also supplied from the vacuum pump at the same time. However, in this case, there is such a concern that the brake negative pressure cannot be secured due to a failure of the vacuum pump.

The present disclosure provides a brake negative pressure control device for a vehicle, and the brake negative pressure control device restrains an insufficient negative pressure of a brake booster in an engine configured such that fuel is injected into both an intake passage and a cylinder.

A brake negative pressure control device for a vehicle according to one aspect of the present disclosure includes an engine, a brake booster, and an electronic control unit. The engine is provided in the vehicle. The engine includes an intake passage, a throttle valve, a first fuel injection valve, and a second fuel injection valve. The throttle valve is configured to throttle a flow of intake air of the intake passage. The first fuel injection valve is configured to inject fuel into a part of the intake passage on a downstream side relative to the throttle valve. The second fuel injection valve is configured to inject the fuel into a cylinder of the engine. The brake booster includes a negative pressure chamber. The negative pressure chamber is configured to create a negative pressure in the negative pressure chamber by the negative pressure in the intake passage. The electronic control unit is configured to: (i) determine whether or not the negative pressure in the negative pressure chamber is insufficient to a brake request; (ii) control the first fuel injection valve and the second fuel injection valve, when the electronic control unit determines that the negative pressure in the negative pressure chamber is insufficient, such that a ratio of a fuel injection amount by the first fuel injection valve in a fuel injection amount of the engine is decreased and a ratio of a fuel injection amount by the second fuel injection valve is increased; and (iii) control an opening degree of the throttle valve, when the electronic control unit determines that the negative pressure in the negative pressure chamber is insufficient, such that the opening degree of the throttle valve at the time when the electronic control unit determines that the negative pressure is insufficient is smaller than an opening degree of the throttle valve at the time when the electronic control unit determined that the negative pressure is not insufficient.

According to the brake negative pressure control device according to the aspect, first, in an operating state of the engine in which the fuel is generally injected into the intake passage by the first fuel injection valve, the negative pressure of the intake passage creates a negative pressure in the negative pressure chamber of the brake booster, so that the brake booster generates an assist force to amplify a brake pedal force in response to this. At this time, the intake negative pressure is sufficiently large in general, and an assist force sufficient to a brake request can be obtained.

In the meantime, when a sufficient negative pressure cannot be obtained for some reason such as a leak of a pipe connected to the negative pressure chamber, for example, the electronic control unit determines whether or not the negative pressure is insufficient, so as to control the first fuel injection valve, the second fuel injection valve, and the throttle valve. In this control, the first fuel injection valve, the second fuel injection valve, and the throttle valve are controlled such that the ratio of the fuel injection amount by the first fuel injection valve is decreased, the ratio of the fuel injection amount by the second fuel injection valve is increased, and the opening degree of the throttle valve is decreased.

When the fuel directly injected into the cylinder from the second fuel injection valve increases as such, a cooling effect of the intake air by its evaporation latent heat considerably increases, so that charging efficiency to the cylinder improves. As a result, a torque of the engine tends to increase, but the opening degree of the throttle valve is decreased, thereby reducing the increase in the torque. That is, it is possible to increase the intake negative pressure by closing the throttle valve, while maintaining the torque of the engine.

Accordingly, when the negative pressure of the brake booster is insufficient due to some sort of malfunction, it is possible to restrain, by the increase of the intake negative pressure, the negative pressure of the brake booster from becoming insufficient and to obtain an assist force that satisfies the brake request. Besides, even if the opening degree of the throttle valve is decreased for that purpose, the torque of the engine is maintained, thereby preventing a decrease in drivability.

In the brake negative pressure control device according to the aspect, the brake booster may include a pressure sensor configured to detect a pressure of the negative pressure chamber. The electronic control unit may be configured to determine that the negative pressure is insufficient, when the pressure of the negative pressure chamber, detected by the pressure sensor, is higher than a predetermined value. According to the brake negative pressure control device according to the aspect, it can be determined with accuracy that the pressure of the negative pressure chamber of the brake booster is insufficient to the brake request. Note that, in a case where the vehicle is equipped with a pressure sensor, a pressure difference (an absolute value) between an atmospheric pressure detected hereby and a detection value by the pressure sensor may be compared with a predetermined value.

In the brake negative pressure control device according to the aspect, the brake booster may include a negative pressure pump. The negative pressure pump may be connected to the negative pressure chamber so as to create a negative pressure to the negative pressure chamber. The electronic control unit may be configured to determine that the negative pressure is insufficient, when the negative pressure pump has a failure. According to the brake negative pressure control device according to the aspect, when a sufficient pump negative pressure cannot be supplied to the brake booster due to the failure of the negative pressure pump and the negative pressure is insufficient, it is possible to restrain the insufficiency of the negative pressure.

In the brake negative pressure control device according to the aspect, the electronic control unit may be configured to control the second fuel injection valve when the electronic control unit determines that the negative pressure is insufficient, such that a fuel injection start timing by the second fuel injection valve is set to a retard side relative to a predetermined timing. In the brake negative pressure control device according to the aspect, the fuel injection by the second fuel injection valve is performed in an intake stroke of the cylinder in general, but when its start timing is set to the retard side relative to the predetermined timing (e.g., 60° to 90° CA after an intake-air top dead center), an adherence amount of fuel spray to a piston decreases, thereby making it possible to further increase a cooling effect of the intake air.

In the brake negative pressure control device according to the aspect, the electronic control unit may be configured to control the engine when the electronic control unit determines that the negative pressure is insufficient, such that a pressure of fuel injection by the second fuel injection valve is set to be higher than a predetermined value. According to the brake negative pressure control device according to the aspect, atomization of the fuel spray injected into the cylinder from the second fuel injection valve is promoted, so that the cooling effect of the intake air further increases. Note that, as the fuel injection pressure is higher, it is possible to promote the atomization of the fuel spray more. However, there is such a possibility that an increase in spray penetration along with this may cause an increase in an adherence amount of the fuel spray to the piston. In view of this, the predetermined value should be set in consideration for the influence of both.

As described above, according to the brake negative pressure control device for the vehicle, according to one aspect of the present disclosure, in the engine configured to inject the fuel into both the intake passage and the cylinder, when the negative pressure to be supplied to the brake booster is insufficient, the ratio of the fuel injection into the cylinder is increased so that the charging efficiency of the intake air is improved, and the opening degree of the throttle valve is decreased by just that much. Hereby, the intake negative pressure can be increased and a sufficient assist force can be obtained by the brake booster. Besides, even if the opening degree of the throttle valve is decreased for that purpose, the torque of the engine can be maintained, thereby preventing a decrease in drivability.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic configuration diagram of a brake negative pressure control device according to an embodiment;

FIG. 2 is a view illustrating a relationship between an operating state of an engine and changes of injection modes;

FIG. 3 is a schematic view illustrating respective injection timings of a port injection injector and a cylinder injection injector;

FIG. 4 is a flowchart view illustrating one example of a control routine to increase an intake negative pressure at the time of failure of a vacuum pump; and

FIG. 5 is a graphical diagram of experiment results of examination on a relationship between a separate injection ratio of fuel and an intake negative pressure.

### DETAILED DESCRIPTION OF EMBODIMENTS

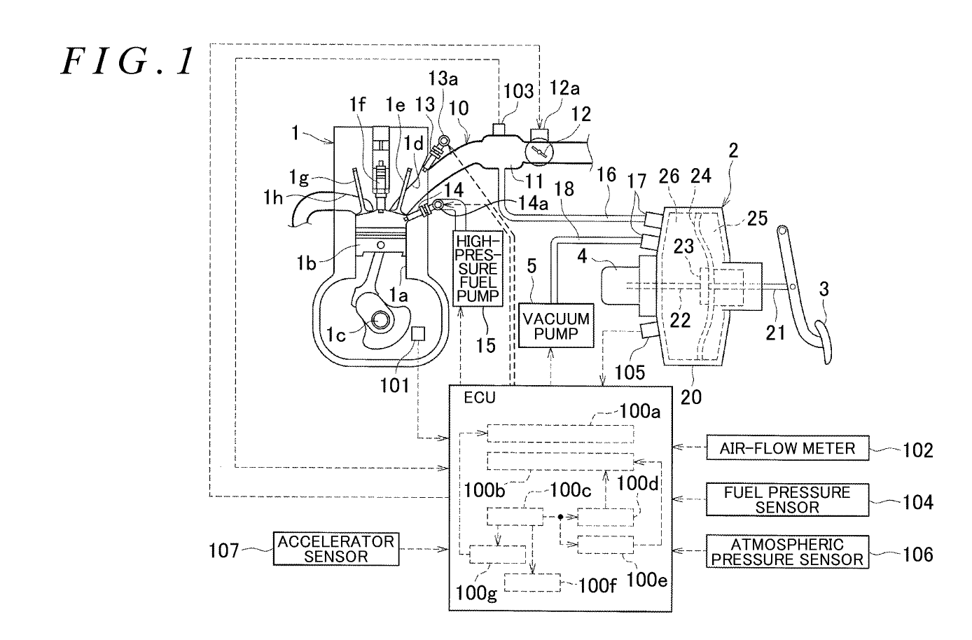

A brake negative pressure control device according to an embodiment of the present disclosure will be described below with reference to the drawings. First, as schematically illustrated in FIG. 1, a braking system according to the present embodiment is configured to supply, to a brake booster 2, a negative pressure (an intake negative pressure) of an intake passage 10 of an engine 1 provided in a vehicle (not shown) and a negative pressure (a pump negative pressure) generated by a vacuum pump 5 (a negative pressure pump).

Schematic Configuration of Engine—In the present embodiment, the engine 1 is a gasoline engine, for example, and as schematically illustrated in FIG. 1, respective pistons 1b (only one of them is illustrated in the figure) accommodated in a plurality of cylinders 1a are connected to a crankshaft 1c via respective connecting rods. A crank angle sensor 101 for detecting a turning angle (a crank angle) of the crankshaft 1cis disposed in the vicinity of the crankshaft 1c.

A combustion chamber is formed above the piston 1b of each cylinder 1a, and an intake port 1d is opened so as to face the combustion chamber on an inclined surface on an intake side (a right side in FIG. 1) in a ceiling portion of the combustion chamber. An intake valve 1e is disposed in the opening, and the intake port 1d extending diagonally upward from here constitutes an end portion of the intake passage 10 on a downstream side of a flow of intake air, as illustrated in FIG. 1.

That is, on an upstream side relative to the intake port 1d (an upstream side of the flow of the intake air), the intake passage 10 first constitutes an intake manifold such that respective independent intake passage of the cylinders 1a are integrated with a surge tank 11. A throttle valve 12 is disposed on the upstream side relative to the surge tank 11, and is operated by an electric throttle motor 12a so as to throttle the flow of the intake air.

An air-flow meter 102 for measuring a flow rate of the intake air, and the like are disposed in a part of the intake passage 10 on the upstream side relative to the throttle valve 12, and an intake pressure sensor 103 is provided in the surge tank 11 on the downstream side relative to the throttle valve 12, in the example illustrated herein. That is, when the flow of the intake air is throttled by the throttle valve 12, a pressure in the intake passage 10 on the downstream side relative to the throttle valve 12, that is, a pressure in the surge tank 11 and the intake port 1d decreases, so that the pressure (an intake negative pressure) is detected by the intake pressure sensor 103.

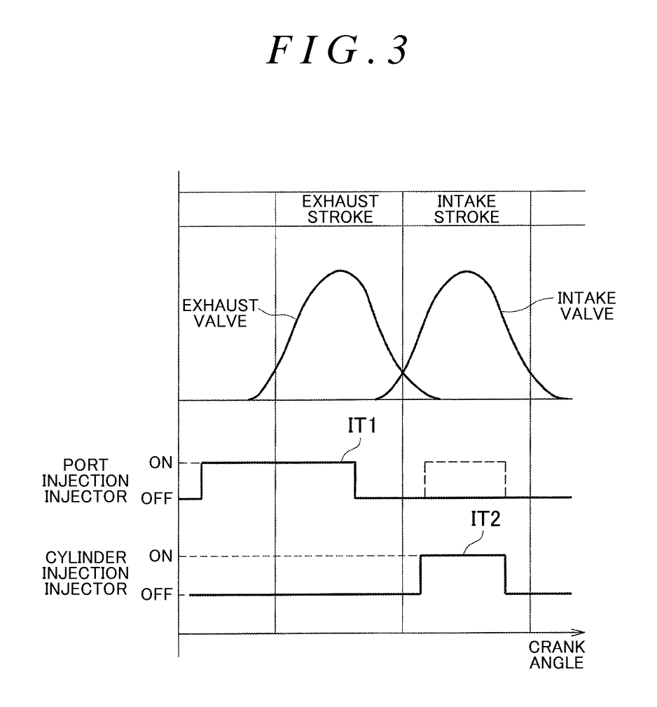

Further, a port injection injector 13 (a first fuel injection valve) is disposed for each cylinder 1a so as to inject fuel into the intake port 1d that has a negative pressure. In the example illustrated herein, the port injection injector 13 is disposed so as to inject the fuel toward a backside of an umbrella portion of the intake valve 1e, and as described below with reference to FIG. 3, the fuel is injected mainly from an expansion stroke to an exhaust stroke of the cylinder 1a.

Further, in the present embodiment, a cylinder injection injector 14 (a second fuel injection valve) is disposed so as to directly inject the fuel into the combustion chamber of each cylinder 1a. The cylinder injection injector 14 is placed so as to inject the fuel diagonally downward from a peripheral portion on an intake side of the cylinder 1atoward a center line, and as described below with reference to FIG. 3, the cylinder injection injector 14 injects the fuel mainly in an intake stroke of the cylinder 1a when the intake valve 1e is opened.

The fuel is supplied from delivery pipes 13a, 14a common to the plurality of cylinders 1a to the port injection injector 13 and the cylinder injection injector 14. Although not illustrated herein, the delivery pipe 13a connected to the port injection injector 13 is connected to a low-pressure fuel supply system configured to supply the fuel drawn up from a fuel tank by an electric pump.

In the meantime, a high-pressure fuel supply system is connected to the delivery pipe 14a connected to the cylinder injection injector 14, so that the fuel to be supplied through a passage branched from the low-pressure fuel supply system is pressurized by the high-pressure fuel pump 15 and then supplied. Further, a fuel pressure sensor 104 for detecting a pressure (a fuel pressure) of the fuel thus pressurized is disposed in the delivery pipe 14a, for example.

The fuel injected from at least one of the port injection injector 13 and the cylinder injection injector 14 is mixed with the intake air so as to form flammable fuel/air mixture in the cylinder 1a, so that the fuel/air mixture is ignited by an ignition plug if to be burned. When this combustion gas pushes down the piston 1b, an engine torque is output from the crankshaft 1c. Further, when the exhaust valve lg is opened, the combustion gas flows out from an exhaust port lh to an exhaust passage.

Braking System—As described above, in the intake passage 10 of the engine 1, when the flow of the intake air is throttled by the throttle valve 12, a negative pressure (an intake negative pressure) is generated in a part of the intake passage 10 on the downstream side relative to the throttle valve 12, that is, in the surge tank 11 and the intake port 1d. In the present embodiment, the intake negative pressure is supplied to the brake booster 2 of the braking system of the vehicle so as to generate an assist force of a brake pedal force.

That is, the brake booster 2 is a vacuum booster for amplifying a pedal force (a brake operation input) of a brake pedal 3 to be stepped by a driver of the vehicle, and a piston 23 provided between an input rod 21 and an output rod 22 is attached to a housing 20 via a diaphragm 24. Further, an inner part of the housing 20 is sectioned by the diaphragm 24 into an atmospheric pressure chamber 25 on an input side and a negative pressure chamber 26 on an output side. When the input rod 21 is pushed according to a stepping operation of the brake pedal 3, an atmospheric pressure is introduced into the atmospheric pressure chamber 25.

In the brake booster 2, an assist force that is proportional to a pressure difference between the atmospheric pressure thus introduced into the atmospheric pressure chamber 25 and the negative pressure of the negative pressure chamber 26 is generated, thereby amplifying the pedal force added to the input rod 21 so as to be input from the output rod 22 to a master cylinder 4. When the master cylinder 4 generates a brake hydraulic pressure (a master cylinder pressure) according to the input, that is, the pedal force of the brake pedal 3 and the assist force of the brake booster 2, the brake hydraulic pressure is supplied to a wheel cylinder of each wheel assembly of the vehicle through a hydraulic circuit (not shown), thereby generating a braking force.

The negative pressure chamber 26 of the brake booster 2 is connected to the intake passage (the surge tank 11 in the example) of the engine 1 via a first negative pressure passage 16. That is, when the flow of the intake air is throttled by the throttle valve 12 as described above, the intake negative pressure generated in the surge tank 11 creates a negative pressure in the negative pressure chamber 26 of the brake booster 2 through the first negative pressure passage 16. Note that a check valve 17 is disposed in a connecting portion between the first negative pressure passage 16 and the negative pressure chamber 26.

Further, the negative pressure chamber 26 is also connected to the electric vacuum pump 5 via a second negative pressure passage 18, and a pump negative pressure is supplied thereto from the vacuum pump 5. Note that a check valve 17 is also disposed in a connecting portion between the second negative pressure passage 18 and the negative pressure chamber 26. Further, a booster pressure sensor 105 for detecting a magnitude of a negative pressure in the negative pressure chamber 26, namely, a booster pressure, is disposed in the negative pressure chamber 26 of the brake booster 2.

Engine Controller—A well-known engine controller unit 100 (hereinafter referred to as the ECU 100) is provided in the vehicle as an engine controller. The ECU 100 includes a CPU (Central Processing Unit), a ROM (Read Only Memory), a RAM (Random Access Memory), a backup RAM, and so on (not shown). The CPU executes various computing processes based on control programs and maps stored in the ROM. Further, the RAM temporarily stores therein computing results in the CPU, data input from various sensors, and the like, and the back-up RAM stores therein data and the like to be stored at the time of stop of the engine 1, for example.

Further, an atmospheric pressure sensor 106, an accelerator sensor 107 of the vehicle, and the like are connected to the ECU 100, in addition to the crank angle sensor 101, the air-flow meter 102, the intake pressure sensor 103, the fuel pressure sensor 104, the booster pressure sensor 105, and the like. Based on signals to be input from these various sensors, switches, and the like, the ECU 100 performs various control programs so as to perform an operation control on the engine 1 as described below, and also performs a control on the brake negative pressure.

First, during the operation of the engine 1, the ECU 100 causes the throttle motor 12a to perform a control on a throttle opening degree (that is, a control on an intake amount), and causes the port injection injector 13 and the cylinder injection injector 14 to perform a fuel injection control. In other words, the ECU 100 includes, as software, a throttle controlling portion 100a (throttle control means) for controlling an opening degree of the throttle valve 12, and a fuel injection controlling portion 100b (fuel injection control means) for controlling the port injection injector 13 and the cylinder injection injector 14.

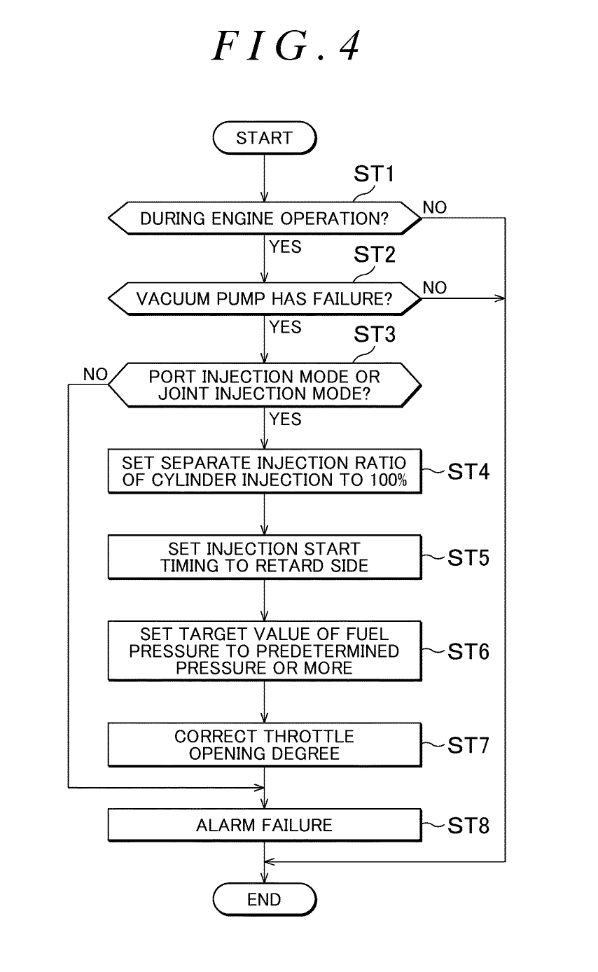

Note that, as will be described later specifically with reference to FIG. 4, in the present embodiment, the ECU 100 includes, as software, a determination portion 100c (determination means) for determining a failure of the vacuum pump 5, a fuel ratio correcting portion 100d (fuel ratio correcting means) for correcting a fuel injection ratio according to the determination, a fuel injection timing setting portion 100e (fuel injection timing setting means) for setting a fuel injection timing to a retard side at this time, an injection pressure setting portion 100f (injection pressure setting means) for setting an injection pressure of the fuel to be higher, and a throttle correction controlling portion 100g (throttle correction control means) for correcting an opening degree of the throttle valve 12 to be smaller according to the determination of the determination portion 100c.

More specifically, for example, the throttle controlling portion 100a calculates a target throttle opening degree based on an engine rotation number calculated from a signal of the crank angle sensor 101 and a requested torque to the engine 1, and outputs a control signal to the throttle motor 12a. Hereby, the throttle opening degree is controlled, so that a throttling degree of the intake air by the throttle valve 12 is changed, and the cylinder 1a is filled with a necessary amount of the fuel/air mixture (that is, a required load factor).

Further, the fuel injection controlling portion 100b calculates an actual intake-air charging efficiency of the cylinder 1a based on a flow rate of the intake air detected by the air-flow meter 102 and the engine rotation number, and calculates a target fuel injection amount so as to achieve a theoretical air-fuel ratio according to the actual intake-air charging efficiency. Further, the fuel injection controlling portion 100b calculates a ratio (a separate injection ratio) between the port injection injector 13 and the cylinder injection injector 14 to inject the target fuel injection amount.

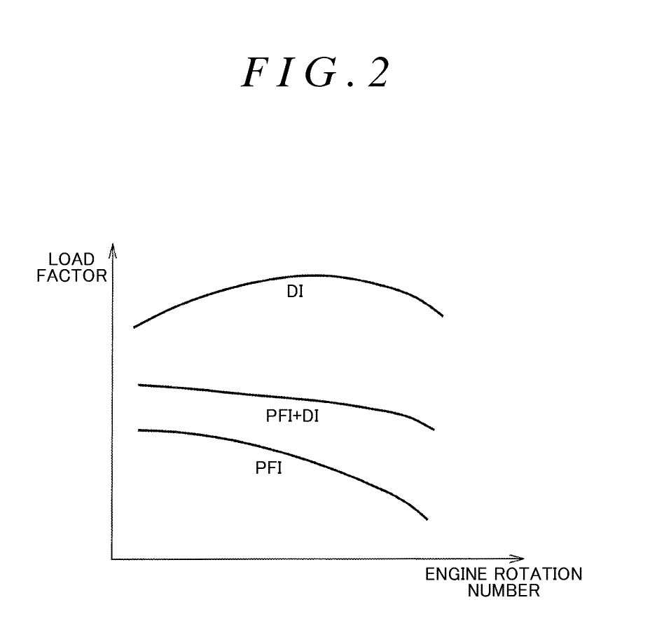

That is, in the present embodiment, operations of the port injection injector 13 and the cylinder injection injector 14 are switched to any of a port injection mode, a cylinder injection mode, and a joint injection mode, as illustrated in FIG. 2, for example, according to the operating state of the engine 1. An operation region (PFI) on a low-load side in which a requested torque to the engine 1 is relatively small is the port injection mode, in which the fuel is injected from the port injection injector 13 so as to be mixed with intake air mainly in the intake port 1d.

At this time, as one example is schematically illustrated in a middle part of FIG. 3, the fuel is injected mainly from the expansion stroke to the exhaust stroke of the cylinder 1a, and fuel spray is vaporized in the intake port 1d having a negative pressure so as to be mixed with the intake air. Thus, it is possible to reduce a driving loss of the engine 1 along with the operation of the high-pressure fuel pump 15, and also to eliminate a risk of deterioration of emission due to the fuel spray being attached to an inner wall of the cylinder 1a and the piston 1b. Note that, as indicated by a broken line in FIG. 3, the fuel may be injected by the port injection injector 13 in the intake stroke of the cylinder 1a.

In the meantime, an operation region (DI) on a heavy load side in which the requested torque to the engine 1 is relatively large is the cylinder injection mode, and as illustrated in a lower part of FIG. 3, the fuel is injected by the cylinder injection injector 14 in the intake stroke of the cylinder 1a. In this case, the fuel spray flows along high-speed airflow to flow into the cylinder 1a from the intake port 1d, so that the flow of the intake air is strengthened and the intake air is effectively cooled down by evaporation latent heat of the fuel spray, so that charging efficiency can be enhanced. This is advantageous to high output.

Further, an operation region (PFI+DI) therebetween is the joint injection mode, in which the fuel injected from the port injection injector 13 is mixed with the intake air in the intake port 1d as described above, and the fuel is injected from the cylinder injection injector 14 in the intake stroke of the cylinder 1a. At this time, respective injection amounts, that is, respective ratios of the fuel injection are such that, as a load factor is larger, a ratio of a fuel injection amount by the port injection injector 13 is decreased, and a ratio of a fuel injection amount by the cylinder injection injector 14 is increased.

Control on Brake Negative Pressure—In addition to the operation control on the engine 1 as described above, in order to create a negative pressure in the negative pressure chamber 26 of the brake booster 2, the ECU 100 operates the vacuum pump 5 during the operation of the engine 1 as needed. That is, when a pressure difference (an absolute value) between a booster pressure (an air pressure) detected by a signal from the booster pressure sensor 105, that is, a magnitude of the negative pressure in the negative pressure chamber 26, and an atmospheric pressure detected by the atmospheric pressure sensor 106 is less than a predetermined value, the vacuum pump 5 is operated.

When the vacuum pump 5 is operated as such, the air is sucked from the negative pressure chamber 26 of the brake booster 2 via the second negative pressure passage 18, in other words, the negative pressure is created in the negative pressure chamber 26. However, due to a failure of the vacuum pump 5 or a leak from the second negative pressure passage 18, for example, a sufficient negative pressure may not be created in the negative pressure chamber 26, so the negative pressure may be insufficient to a brake request.

In view of this, if it is determined that a sufficient pump negative pressure is not supplied to the brake booster 2 due to some sort of malfunction in either of the operation regions of the port injection mode (PFI) and the joint injection mode (PFI+DI) described above with reference to FIG. 2, the ECU 100 performs a control (hereinafter referred to as an intake negative pressure increase control) to increase an intake negative pressure by increasing the fuel injection ratio by the cylinder injection injector 14 and by decreasing the throttle opening degree.

The following describes a control to increase the intake negative pressure of the engine 1 as described above, with reference to FIG. 4. A routine of this control is performed repeatedly at a predetermined timing while an ignition switch of the vehicle is turned on, for example.

First, it is determined whether or not the engine 1 is operated in step ST1 after start. When the engine 1 stops, a negative determination is made (NO), and the routine is finished (END). In the meantime, when the engine 1 is operated, an affirmative determination (YES) is made, and the process proceeds to step ST2, in which it is determined whether or not the vacuum pump 5 has a failure or not. This can be determined, for example, by a change of a signal output from the booster pressure sensor 105 by operating the vacuum pump 5.

When the determination is NO (negative determination), the routine is finished (END). In the meantime, when it is determined that the vacuum pump 5 has a failure (YES), the process proceeds to step ST3, in which it is determined in which operation region (see FIG. 2) the engine 1 operates, the port injection mode or the joint injection mode. When the engine 1 operates in the operation region of the cylinder injection mode and a negative determination is made (NO), a separate injection ratio of cylinder injection is 100%, and the ratio of the cylinder injection cannot be increased further, so the process proceeds to step ST8 (described later).

In the meantime, when the operation region is either of the port injection mode and the joint injection mode, the separate injection ratio of the cylinder injection is not 100%, which can be changed so that the ratio of the cylinder injection increases. Accordingly, an affirmative determination (YES) is made and the process proceeds to step ST4, in which the separate injection ratio of the cylinder injection is set to 100%. That is, the fuel injection is set so as to be performed only by the cylinder injection injector 14 without operating the port injection injector 13, and subsequently, in step ST5, a fuel injection start timing by the cylinder injection injector 14 is set to a retard side relative to a predetermined timing.

That is, the fuel injection by the cylinder injection injector 14 is started generally in an earlier period (the earlier period when the intake stroke is divided into three periods including the earlier period, a middle period, and a latter period) of the intake stroke. However, in this case, part of the fuel spray is once attached to a crestal plane of the piston 1b, and then evaporates so as to form fuel/air mixture, and thus, the fuel cools down the piston 1b. Consequently, cooling efficiency of the intake air decreases by just that much. In view of this, for example, the fuel injection start timing is set to the retard side relative to 60° CA after an intake top dead center (preferably, 90° CA after the intake top dead center), so as to restrain the adherence of the fuel spray to the piston 1b as small as possible, thereby making it possible to further increase the cooling effect of the intake air.

Further, a target value of the fuel pressure is set to a predetermined pressure or more in subsequent step ST6. This is to promote atomization of the fuel spray to be injected into the cylinder 1a by the cylinder injection injector 14 and to further increase the cooling effect of the intake air. As the fuel pressure is higher, it is possible to promote the atomization of the fuel spray more. However, there is such a possibility that an increase in spray penetration along with this may cause an increase in an adherence amount of the fuel spray to the piston 1b. In view of this, the predetermined pressure is set to an optimum value based on examination through experiment on a decrease of the intake-air cooling effect due to the increase in the adherence amount of the fuel spray and an improvement of the intake-air cooling effect due to promotion of the atomization of the fuel spray.

Thus, the fuel injection ratio into the cylinder 1a is set to 100% and the fuel injection timing is retarded so as to decrease a fuel adherence amount to the piston 1b, and the atomization of the fuel spray is promoted by an increase of the fuel pressure, so that the cooling effect of the intake air by its evaporation latent heat considerably increases. Hereby, the charging efficiency to the cylinder 1a increases and a torque of the engine 1 tends to increase. In view of this, in step ST7, the throttle opening degree is corrected to become small so as to decrease the flow rate of the intake air, thereby reducing an increase in the torque.

That is, an improved amount of the charging efficiency due to the increase in the cooling effect of the intake air is examined in advance through experiment and simulation according to the operating state of the engine 1, and a decrease correction amount of the throttle opening degree to cancel this is adjusted and set as a map. This map is stored in the ROM of the ECU 100, and in step ST7, the throttle opening degree is corrected with reference to the map.

Hereby, it is possible to decrease the opening degree of the throttle valve 12 while maintaining the torque of the engine 1 and to increase the intake negative pressure, thereby preventing a decrease in drivability. Further, the negative pressure of the negative pressure chamber 26 created by the intake negative pressure increases, so that a larger assist force is generated in the brake booster 2. In view of this, the process proceeds to step ST8 so as to alarm the failure of the vacuum pump 5 to the driver of the vehicle, and the routine is finished (END).

By performing step ST2 of the flow in FIG. 4, the ECU 100 constitutes the determination portion 100c (see FIG. 1) configured to determine that the vacuum pump 5 has a failure and the brake negative pressure is insufficient to the brake request. Further, by performing step ST4, the ECU100 constitutes the fuel ratio correcting portion 100d configured to correct the control by the fuel injection controlling portion 100b, so that the ratio of the fuel injection amount by the port injection injector 13 is decreased and the ratio of the fuel injection amount by the cylinder injection injector 14 is increased at the time of the determination.

Further, by performing step STS, the ECU 100 constitutes the fuel injection timing setting portion 100e configured to set the fuel injection start timing by the cylinder injection injector 14 to the retard side relative to the predetermined timing at the time when the vacuum pump 5 is determined to have a failure as described above. Furthermore, by performing step ST6, the ECU 100 constitutes the injection pressure setting portion 100f configured to set the fuel injection pressure by the cylinder injection injector 14 to be higher than the predetermined pressure.

Furthermore, by performing step ST7 of the flow in FIG. 4, the ECU 100 constitutes the throttle correction controlling portion 100g configured to correct the control by the throttle controlling portion 100a so that the opening degree of the throttle valve 12 is decreased at the time when the vacuum pump 5 is determined to have a failure as described above.

Thus, as described above, according to the brake negative pressure control device according to the present embodiment, in a case where the engine 1 includes the port injection injector 13 and the cylinder injection injector 14, when it is determined that the negative pressure to be supplied to the brake booster 2 is likely to become insufficient due to a failure of the vacuum pump 5, the injection ratio of the fuel into the cylinder 1a by the cylinder injection injector 14 is increased so as to improve the charging efficiency of the intake air while the opening degree of the throttle valve 12 is decreased by just that much, thereby making it possible to increase the intake negative pressure.

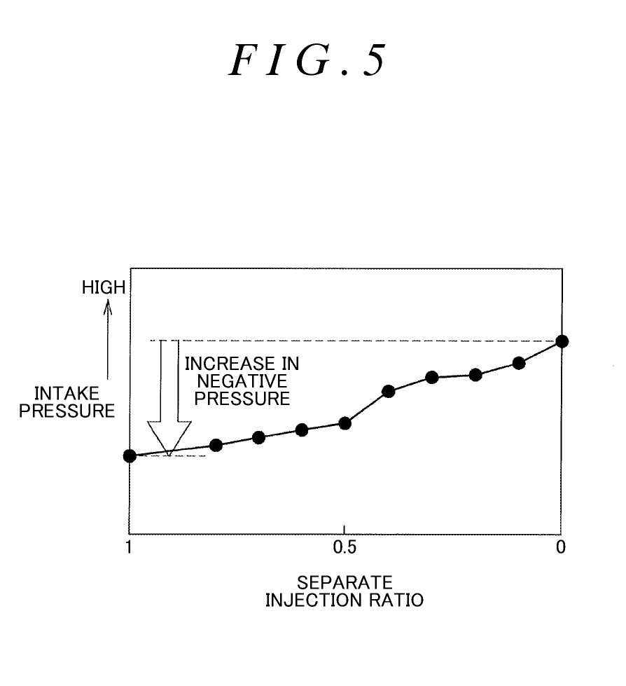

That is, as illustrated in FIG. 5 that illustrates one example of experiment results of examination on how the intake negative pressure changes due to changes of the fuel injection ratio (the separate injection ratio), it is found that, at the time when the cylinder injection is 100% (the separate injection ratio is 1), the intake negative pressure is increased by approximately 5% as compared with a time when the port injection is 100% (the separate injection ratio is 0). Therefore, by supplying the intake negative pressure increased as such, even if the vacuum pump 5 has a failure, it is possible to supply a necessary negative pressure to the brake booster 2 so as to obtain an assist force that satisfies the brake request.

Particularly, in the present embodiment, the fuel injection ratio by the cylinder injection injector 14 is set to 1 (that is, the cylinder injection is 100%) and the injection start timing is set to the retard side, so as to reduce the adherence of the fuel spray to the piston 1b and to increase the fuel pressure, thereby promoting atomization of the fuel spray. This accordingly makes it possible to increase the cooling efficiency of the intake air as much as possible due to a synergistic effect thereof and to improve the charging efficiency to the maximum. As a result, it is possible to decrease the opening degree of the throttle valve 12 to be considerably small by just that much and to sufficiently increase the intake negative pressure.

Other Embodiments—The above embodiment is just an example, and is not intended to limit a configuration, a purpose, and the like of the present disclosure. For example, in the above embodiment, in step ST2 of the flowchart of FIG. 4, it is determined whether or not the vacuum pump 5 has a failure. Alternatively, or in addition to this, it may be determined that the brake negative pressure is insufficient based on a detection value of the booster pressure sensor 105.

That is, it may be determined that the brake negative pressure is insufficient when a pressure difference between a detected booster pressure and an atmospheric pressure does not satisfy a brake requested value set in advance. With such a configuration, it is also possible to determine that a sufficient brake negative pressure cannot be obtained due to a leak or the like in pipes (the first and second negative pressure passages 16, 18) that supply the negative pressure to the negative pressure chamber 26 of the brake booster 2, for example.

Further, in the above embodiment, in order to increase the intake negative pressure, the fuel injection ratio by the cylinder injection injector 14 is set to 1 (that is, the cylinder injection is 100%), the injection start timing is set to the retard side, and the fuel pressure is increased. However, the present disclosure is not limited to this. For example, the fuel injection start timing may not be retarded or the fuel pressure may not be increased, and the ratio of the cylinder injection may not be set to 100%, but may be set to a ratio set in advance, such as 90% and 80%.

That is, when the ratio of the cylinder injection of the fuel increases, deviation of concentration distribution of the fuel/air mixture becomes larger along with this, which may deteriorate a combustion state. Accordingly, it is preferable to adjust, by experiment or the like, a ratio that can increase an effect of increasing the intake negative pressure by increasing the ratio of the cylinder injection as described above without causing such an adverse effect as much as possible.

Further, when the ratio of the cylinder injection is increased as such, the fuel injection by the cylinder injection injector 14 may be performed in a divided manner into several times. The spray of the fuel thus injected in a divided manner into several times is easily mixed with the intake air, so that it is possible to restrain the deviation of the concentration distribution of the fuel/air mixture and to further increase the cooling effect of the intake air.

Further, in the braking system of the above embodiment, the negative pressure chamber 26 of the brake booster 2 is created by the intake negative pressure and the pump negative pressure. However, the present disclosure is not limited to this, and the present disclosure is also applicable to a braking system not equipped with the vacuum pump 5, but configured to supply the intake negative pressure only to the brake booster 2.

Further, the engine 1 of the above embodiment includes the cylinder injection injector 14 on the intake side of the cylinder 1a in addition to the port injection injector 13. However, the present disclosure is not limited to this, and the cylinder injection injector may be placed so as to inject the fuel from the vicinity of the ignition plug if along a center line of the cylinder 1a, for example.

Further, the above embodiment deals with a case where the present disclosure is applied to the vehicle equipped with the gasoline engine 1, as an example. However, the present disclosure is not limited to this, and the present disclosure is also applicable, for example, to a vehicle equipped with an engine that uses alcohol fuel or gaseous fuel, and is also applicable to a hybrid vehicle equipped with such an engine and an electric motor for running.

In the present disclosure, when a brake negative pressure is likely to become insufficient due to a failure of a vacuum pump, for example, an intake negative pressure is increased temporarily to secure the brake negative pressure. In view of this, the present disclosure is highly effective when it is applied to a braking system of a passenger car, for example.

What is claimed is:

1. A brake negative pressure control device for a vehicle, the brake negative pressure control device comprising:
an engine provided in the vehicle, the engine including an intake passage, a throttle valve, a first fuel injection valve, and a second fuel injection valve, the throttle valve being configured to throttle a flow of intake air of the intake passage, the first fuel injection valve being configured to inject fuel into a part of the intake passage on a downstream side relative to the throttle valve, the second fuel injection valve being configured to inject the fuel into a cylinder of the engine;
a brake booster including a negative pressure chamber, the negative pressure chamber being configured to create a negative pressure in the negative pressure chamber by the negative pressure in the intake passage; and
an electronic control unit configured to:
(i) determine whether or not the negative pressure in the negative pressure chamber is insufficient to a brake request;
(ii) control the first fuel injection valve and the second fuel injection valve, when the electronic control unit determines that the negative pressure in the negative pressure chamber is insufficient, such that a ratio of a fuel injection amount by the first fuel injection valve in a fuel injection amount of the engine is decreased and a ratio of a fuel injection amount by the second fuel injection valve is increased; and
(iii) control an opening degree of the throttle valve, when the electronic control unit determines that the negative pressure in the negative pressure chamber is insufficient, such that the opening degree of the throttle valve at the time when the electronic control unit determines that the negative pressure is insufficient is smaller than an opening degree of the throttle valve at the time when the electronic control unit determines that the negative pressure is not insufficient.

2. The brake negative pressure control device for the vehicle, according to claim 1, wherein:
the brake booster includes a pressure sensor configured to detect a pressure of the negative pressure chamber; and
the electronic control unit is configured to determine that the negative pressure is insufficient, when the pressure of the negative pressure chamber, detected by the pressure sensor, is higher than a predetermined value.

3. The brake negative pressure control device for the vehicle, according to claim 1, wherein:
the brake booster includes a negative pressure pump, the negative pressure pump being connected to the negative pressure chamber so as to create a negative pressure in the negative pressure chamber; and
the electronic control unit is configured to determine that the negative pressure is insufficient, when the negative pressure pump has a failure.

4. The brake negative pressure control device for the vehicle, according to claim 1, wherein
the electronic control unit is configured to control the second fuel injection valve when the electronic control unit determines that the negative pressure is insufficient, such that a fuel injection start timing by the second fuel injection valve is set to a retard side relative to a predetermined timing.

5. The brake negative pressure control device for the vehicle, according to claim 1, wherein
the electronic control unit is configured to control the engine when the electronic control unit determines that the negative pressure is insufficient, such that a pressure of fuel injection by the second fuel injection valve is set to be higher than a predetermined value.
